(19) United States
(12) Patent Application Publication
(10) Pub. No.: US 2025/0077402 A1
(43) Pub. Date: Mar. 6, 2025

(54) PRESERVING INTEGRATION THROUGHOUT MULTIPLE CONVERSION SIMULATIONS

(71) Applicant: SAUDI ARABIAN OIL COMPANY, Dhahran (SA)

(72) Inventors: Ali Hussain Abualsaud, Seyaht (SA); Hazem Abdulmoeen Algerafi, Dammam (SA)

(73) Assignee: SAUDI ARABIAN OIL COMPANY, Dhahran (SA)

(21) Appl. No.: 18/457,722

(22) Filed: Aug. 29, 2023

(51) Int. Cl. G06F 11/36

(52) U.S. Cl. CPC G06F 11/3698

(57) ABSTRACT

A method of preserving integration of an entity enterprise network throughout multiple system conversion simulations comprises reproducing an application server and a database coupled to the application in a test box, executing a program script to locate all inbound and outbound integrations that connect the test box to other servers in the enterprise network in the manner of the reproduced application server and database, configuring all of the inbound and outbound integrations of the test box, exporting all of the configured inbound and outbound integrations in a configuration repository, and performing a conversion simulation on the test box and enterprise network. In all future conversion simulations in which a new test box is created, inbound and outbound configurations can be imported from the configuration repository.

### FIELD OF THE DISCLOSURE

The present disclosure related to information technology, and more particularly relates to a system and method of preserving integration throughout multiple system conversion simulations.

### BACKGROUND OF THE DISCLOSURE

Organizations use enterprise resource planning systems and software to aid in running a business, including supporting automation and processes in finance, human resources, manufacturing, supply chain, services, and procurement, among others. Vendors such as SAP and Oracle provide such software and accompanying database platforms. Two well-known examples of ERP software suites are the SAP 4/HANA™ platform and the Oracle Fusion Cloud™. One of the benefits of using an ERP system is the seamless connectivity it enables between different types of applications. However, such seamless connectivity hides a great deal of complexity; there are a vast number of configuration parameters that need to be set and updated appropriately for such connectivity to occur.

As a simplified but illustrative example, let us say Server A is an application server that provides a sales interface to customers, server B is an application server through which deliveries are arranged, and server C hosts a financial application. In a given sale, server A may receive and record a new order and send messages to both server B and server C. Server B may provide an interface for receiving delivery information including locations and means of delivery, while server C may monitor the transaction for associated financial payments and transfers. The communication between the servers to accomplish these goals can involve the transmission and receipt of a number of protocol messages and data exchanges to ensure integrity and security. To ensure security in particular, the connectivity between distinct server sub-systems can require entry and confirmation of passwords from specific entities, and other specific data transfers such as permissions (indicia of trust) and licenses.

In short, ERP systems require a vast amount of configuration to properly generate such messages, transmit them to the correct sub-systems, arrange for permissions, etc. Conventionally, such configurations are set and/or updated manually by information technology staff. This task can be onerous in itself but is multiplied considerably when an organization decides to migrate or converts to a different ERP platform or to significantly update an existing platform. Robust testing of any new and updated ERP system is required to ensure that all sub-systems work together correctly and securely. Testing is performed by multiple simulations in which a production system is exactly reproduced in “test boxes”. In a given simulation Server A is reproduced as Test Box Server A′ and server B is reproduced as Test Box Server B′, etc. However, configuration information cannot be automatically reproduced because, by definition, such information, including passwords, permissions, licenses and so on, are obtained externally in a live system. Accordingly, to perform each conversion simulation, the configuration needs to be redone manually. In a complex organization, a migration to a new ERP platform can entail thousands of test scenarios, and the manual reconfiguration for each simulation is highly burdensome for technical personnel.

What is therefore needed is a way to reduce the onerous burden involved in multiple conversion simulations.

### SUMMARY OF THE INVENTION

In one aspect, the present disclosure describes a method of preserving integration of an entity enterprise network throughout multiple system conversion simulations comprises reproducing an application server and a database coupled to the application in a test box, executing a program script to locate all inbound and outbound integrations that connect the test box to other servers in the enterprise network in the manner of the reproduced application server and database, configuring all of the inbound and outbound integrations of the test box, exporting all of the configured inbound and outbound integrations in a configuration repository, and performing a conversion simulation on the test box and enterprise network. In all future conversion simulations in which a new test box is created, inbound and outbound configurations can be imported from the configuration repository.

In certain embodiments, the method further comprises, after an initial simulation, reproducing the application server and the database coupled to the application server in the test box again, importing the inbound and outbound configurations to the test box from the configuration repository, and performing a conversion simulation on the test box and enterprise network.

In certain embodiments, the integrations include application link enabling structured data messages. The integrations can also or alternatively include include remote function calls, and/or include trust configurations required to receive a trusted remote functional call connection.

In another aspect, the present disclosure describes an enterprise system for which multiple system conversion simulations are performed. The enterprise system comprises a network of connected application servers, each application server being coupled to a database, a test box comprising a copy of one of the application servers and the database coupled to the application server, and a configuration repository coupled to the test box. The test box executes a program script to locate all inbound and outbound integrations that functionally connect the test box to the application servers in the enterprise network in the manner of the copied application server and database. All of the inbound and outbound integrations of the test box are configured, and the configured integrations are exported to the configuration repository.

### BRIEF DESCRIPTION OF THE DRAWINGS

FIG. 1 is a schematic illustration of the basic system unit that is reproduced for simulation according to embodiments of the present disclosure.

FIG. 2 is a schematic diagram illustrating the configuration of out-bound and in-bound configurations of a test box application server according to an embodiment of the present disclosure.

FIG. 3 shows an example initial screen of an interface for configuring application link enabling.

FIG. 4 shows an example second screen of the ALE configuration interface that follows from FIG. 3.

FIG. 5 shows an example third screen of the ALE configuration interface that follows from FIGS. 3 and 4.

FIG. 6 shows an example initial screen of an interface for configuring RFCs.

FIG. 7 shows an example screen of an interface for configuring RFCs related to FIG. 6 in which a Logon Settings tab has been selected.

FIG. 8 is an example screen of an interface for creating a new trust relationship for RFCs.

FIG. 9 is an example screen of an interface for license administration.

FIG. 10 is a flow chart of a flow chart of a method of preserving integration throughout multiple system conversion simulations according to an embodiment of the present disclosure.

### DETAILED DESCRIPTION OF CERTAIN EMBODIMENTS OF THE DISCLOSURE

The present disclosure describes a method of preserving integration of an entity enterprise network throughout multiple system conversion simulations. One of the salient features of this method is that application servers and databases of an enterprise network are reproduced in test boxes. In addition to reproducing the static data of the servers and databases, the various dynamic functional connections between the various application servers of the system need to be reproduced as well to perform a suitable conversion simulation. The various functional connections, termed “integrations” are configured a single time, and then the configurations are exported to a secure repository. In all subsequent conversion simulations, configuration is not necessary as all inbound and outbound integrations are imported to the test boxes, eliminating the time normally required to configure the integrations for each simulation.

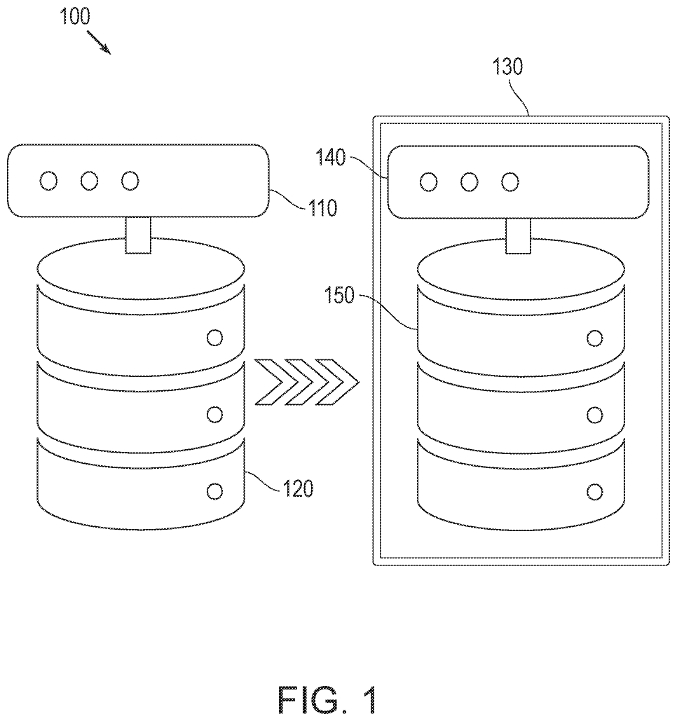

FIG. 1 is a schematic illustration of the basic system unit that is reproduced for simulation according to embodiments of the present disclosure. The original system unit 100 includes an application server 110 which is coupled to a database 120. The application server 110 is configured to execute one or more applications in a network environment. The application server 110 accesses and utilizes data contained in database 120, including configuration data. Importantly, the database 120 can include information regarding how the application server is configured for connections and messaging to other application servers of the network. The database 120 can be integrated into a commercial database management system (adapted for Enterprise Resource Planning) such as SAP™ 4/HANA, Oracle™ Fusion or NetSuite, and Microsoft™ Dynamics 365. A reproduced system unit 130, also referred to as a “test box” includes a reproduced application server 140 coupled to a corresponding reproduced database 150. The test box reproduces the original system unit 100 exactly. Application server 140 is configured in exactly the same way as application server 110 and database 150 includes the same data as database 120 and runs using the same platform, using code that configures a hardware processor and executes therein to provide the functionality described in the following paragraphs.

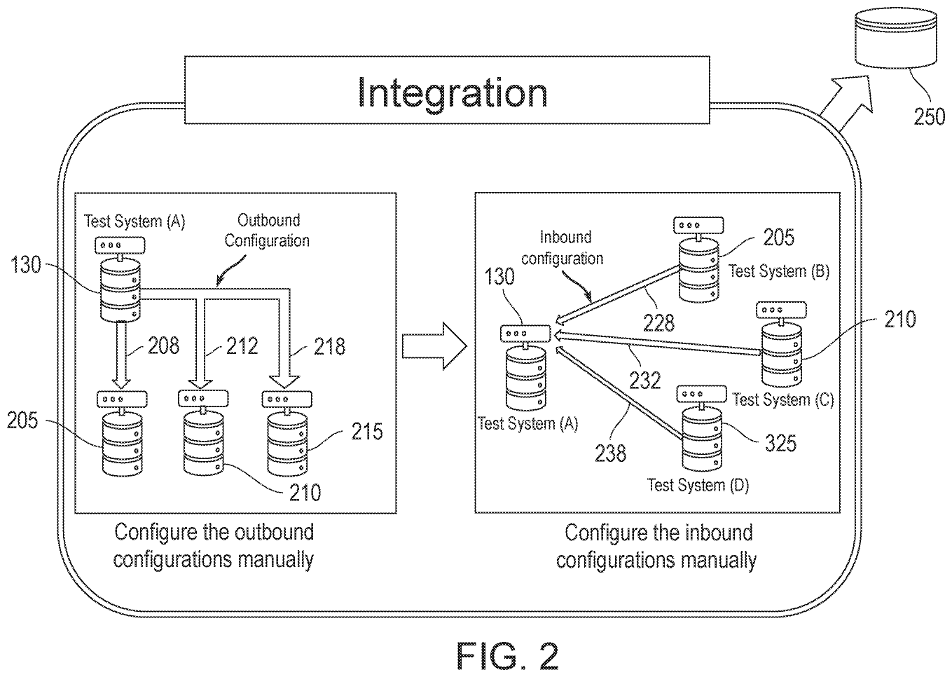

FIG. 2 is a schematic diagram illustrating the configuration of out-bound and in-bound configurations of a test box application server according to an embodiment of the present disclosure. On the left part of FIG. 2, test box 130 is shown connected to three other servers 205, 210, 215. More specifically, there is an outbound connection 208 between test box 130 and server 205, another outbound connection 212 between test box test box 130 and server 210, and a further outbound connection 218 between test box 130 and server 215. The connections between test box 130 and servers 205, 210, 215 replicate the connections that exist between the original application server and the other servers 205, 210, 215 within the organizational network. The configurations are considered “outbound” in that the connections are established through information that is generated by the test box server 130. For example, initiation of a connection between test box 130 and server 210 may require a trust certificate to be sent from the test box to the server. The trust certificate may need to be configured with password or other information that cannot be directly copied from the original server to the test box 130. Thus, in the initial reproduction (simulation) this configuration information is supplied by relevant IT personnel when the outbound connections are first made. Once the outbound configurations are set, a script is executed that runs commands on the database of the integrated system and records the integrations in a static “integration records” file. This file is thereafter used in the import (reintegration) process. An additional script contains database commands that uses the integration records file as an input and reestablishes the integrations accordingly.

On the right part of FIG. 2, test box 130 is also shown connected to servers 205, 210, 215. In this case, the connections are “inbound” rather than outbound, meaning that the connection is initiated by servers 205, 210, 215 rather than test box 130. More specifically, there is an inbound connection 228 between test box 130 and server 205, another outbound connection 232 between test box test box 130 and server 210, and a further outbound connection 238 between test box 130 and server 215. The inbound connections between test box 130 and servers 205, 210, 215 replicate the inbound connections that exist between the original application server and the other servers 205, 210, 215 within the organizational network, using the same protocols for communication as are standard in the network (e.g., HTTP, SQL messaging, etc.). Once the inbound configurations are set, they are also exported to the configuration repositor 250.

There are a number of different types of messages, protocols and other configurations (referred to together as “integrations”) that need to be set properly in a simulation. Some of the messages are proprietary to ERP vendors, such as SAP or Oracle. Thus, in order to test the integration of particular vendor's ERP correctly, some of the integrations need to be set according to that particular vendor's requirements. In the case of an SAP integration, the integrations include Application Link Enabling (ALE), Remote Function Calls (RFCs), Trust messages, Licenses, and Logon Groups. ALE messages are structured data messages that are exchanged between systems. For example, financial postings can be sent as ALE messages from one system to another. ALE setup requires suitable configurations on the systems that communicate with each other. RFCs are communicated using a proprietary protocol that establishes the connection between systems. Trust messages (e.g., proof of authorization or identity) are required by SAP configurations to receive a trusted RFC connection. Regarding licenses, an SAP software license configuration is required to start the system. The license configuration is generated by SAP based on the hardware/database of the system. Logon groups comprise a load balancing configuration that is dependent on the name of the application server.

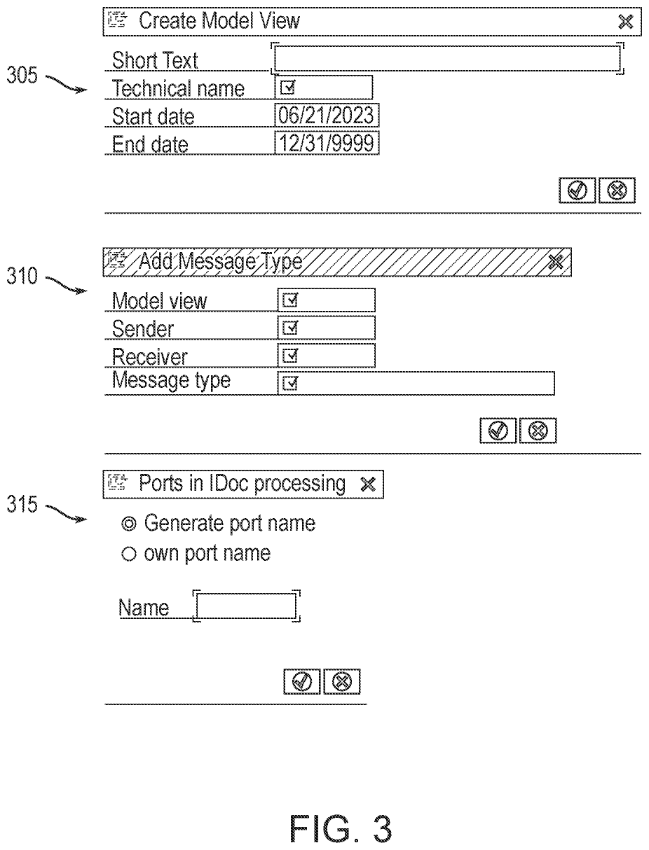

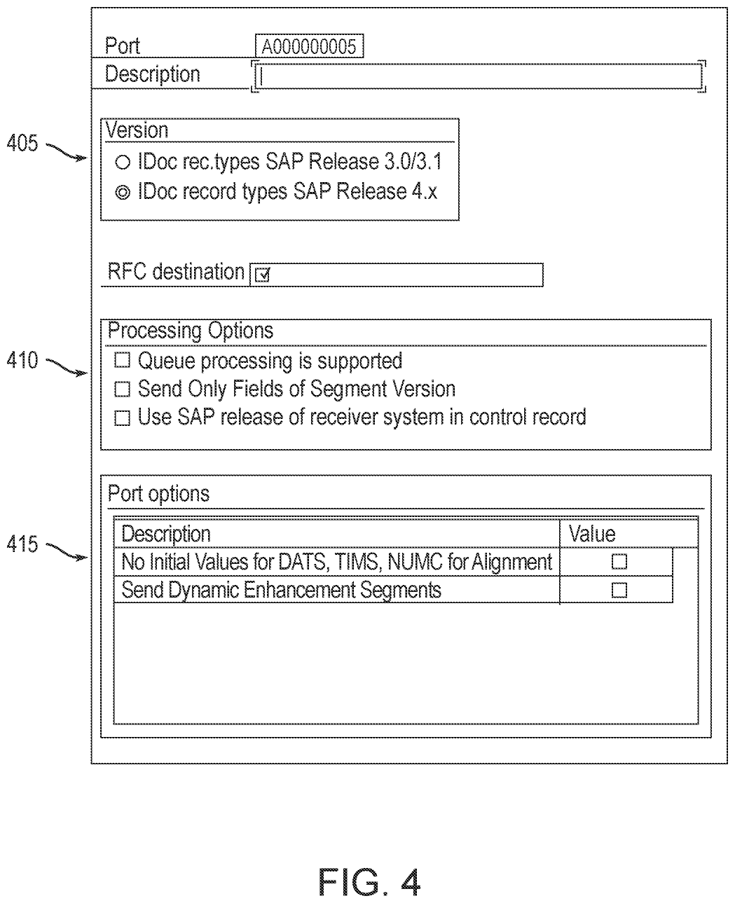

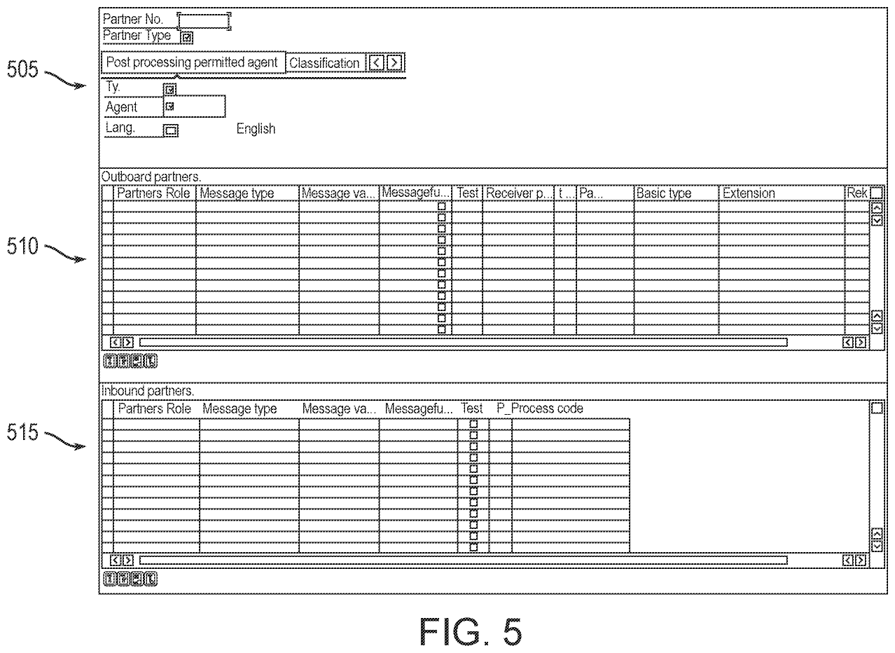

FIG. 3 shows an example initial screen of an interface for configuring application link enabling. This configuration is performed for the outbound and inbound ALE connections of the test box at the first simulation. As shown, the screen shown in FIG. 3 includes three sections, a first section 305 for identifying the connection, a second section 310 for setting a message type of the ALE, and a third section 315 for generating a port name through which the message is to be sent (or received). FIG. 4 shows an example second screen of the ALE configuration interface that follows from FIG. 3. The second screen also includes three sections: a first section 405 that allows the user to set the version of the SAP release of the IDOC record types; a second section 410 for further processing options and a third section for further port options. An exemplary third and final screen of the ALE interface is shown in FIG. 5. This screen also includes three sections that comprise a section for receiving notifications of posted ALE messages 505, an outbound message parameter list 510 and an inbound message parameter list 515. The notification receipt section 505 is useful in case of technical posting failures as there could be actions that need to be executed to resolve failures. The lists of inbound/outbound message parameters 510, 515 define the messages that are exchanged between systems. In addition, for each outbound message, the receiving partner system is defined. Upon completing the various options and settings in the ALE interface, all of the setting information is exported to the configuration repository.

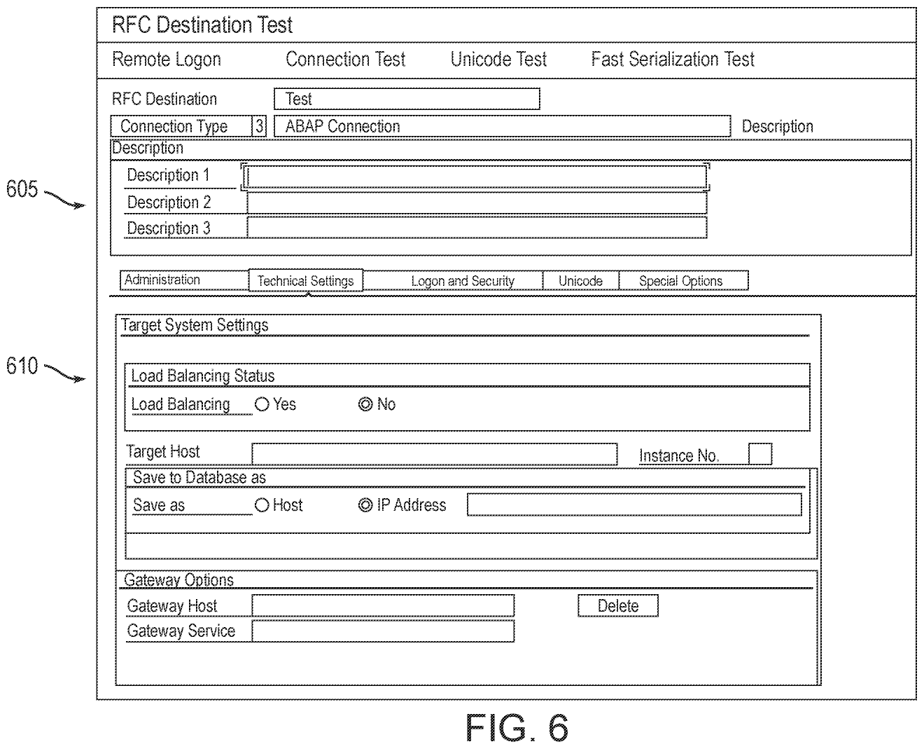

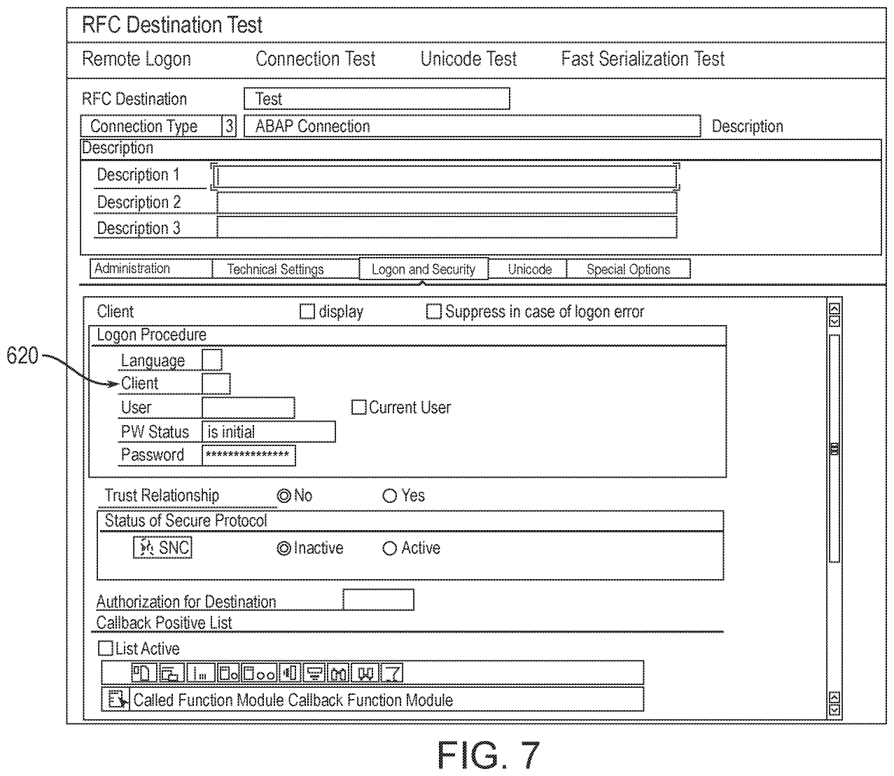

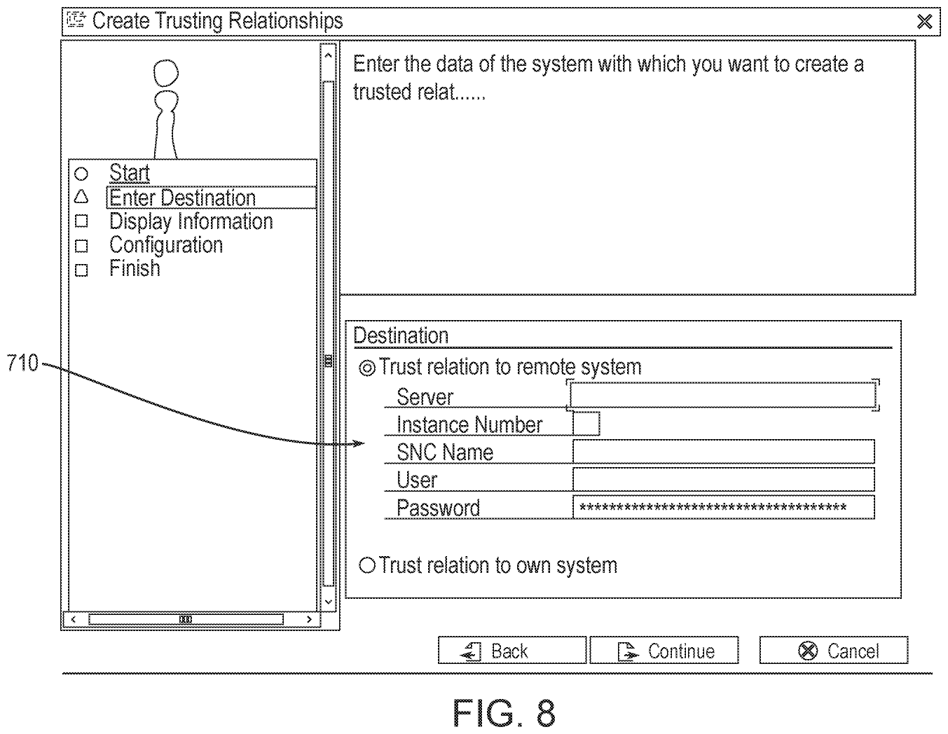

Another of the integrations that needs to be configured is Remote Functional Calls (RFCs). FIG. 6 shows an example screen of an interface for configuring RFCs in which a Technical Settings tab has been selected. This screen includes two main sections, a first section 605 that identifies the destination of the remote call and describes the connection type. In the example, the connection type is ABAP, which is the Advanced Business Application Programming language supported by SAP ERP systems. ABAP connections establish and ABAP program calling interface. Section 605 also provides fields for input of further descriptive data. Section 610 includes technical setting for the RFC. Depending on the connection type, there are various basic settings on this tab page for the target system and the gateway. In this section the user can specify the Target host, which is the name of the server host of the target system used as a port to the system, or alternatively, load balancing can be selected in which case the port is chosen based on present loads on the system. The load balancing configuration is dependent on the name of the application server. FIG. 7 shows a related example screen 620 of an interface for configuring RFCs in which a Logon Settings tab has been selected. The options in the logon setting tab enable users to configure various logon data, authentication methods, and security options, depending on the connection type. At the bottom of the logon settings 620 is a radio button that allows the user to specify whether the RFC destination has a trusted relationship with the sender. FIG. 8 is an example screen of an interface for creating a new trust relationship for RFCs. In a Destination section 710, the user can create a trusted relationship between entering a server name, providing an instance number and a Secure Network Communication (SNC) name. User and password information is necessary to create the trust relationship.

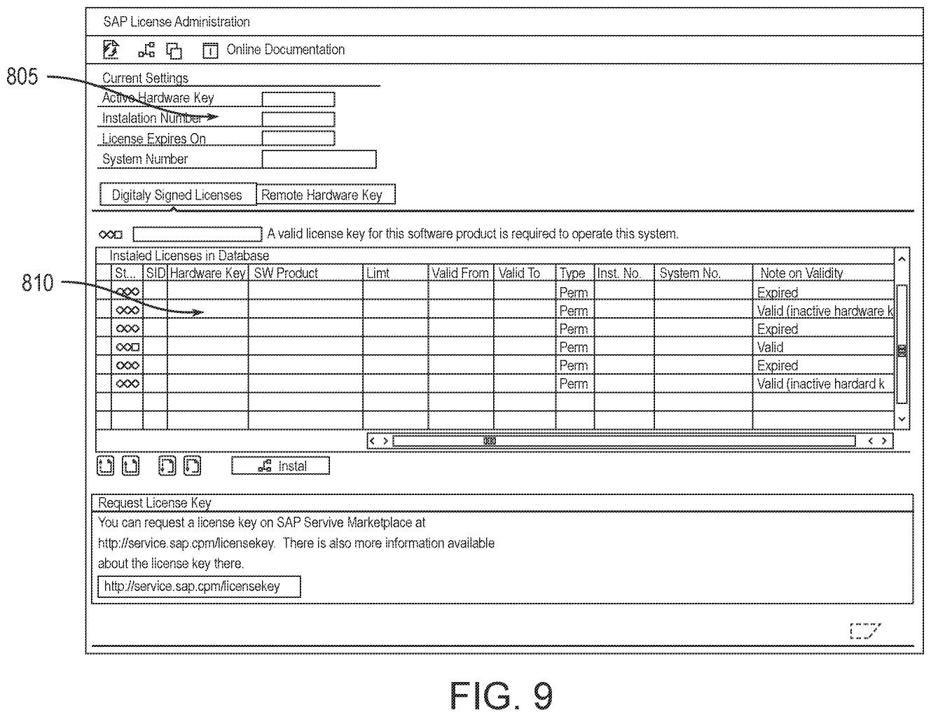

FIG. 9 is an example screen of an interface for license administration, in this case for an SAP license. The interface includes a current license section 805 which includes characteristics of the current SAP license such as an active hardware key, an installation number and an expiration date. The interface also includes a digital signed license section 810 which lists all licenses with respect to the vendor that are stored in the customer database. The license configurations are set by the vendor based on hardware and database of the system.

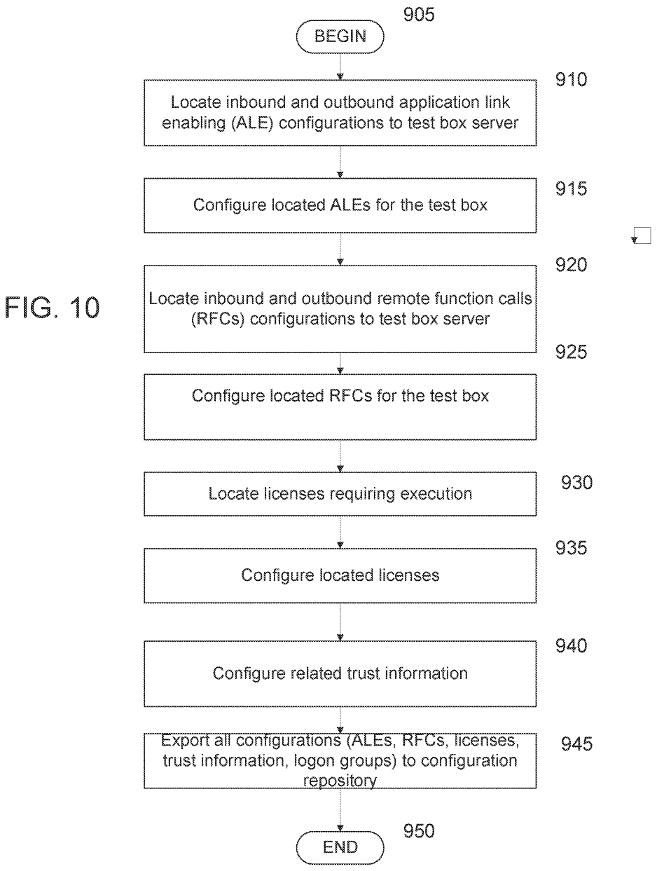

FIG. 10 is a flow chart of a method of preserving integration throughout multiple system conversion simulations according to an embodiment of the present disclosure. The method applies to the initial configuration of a test box that is reproduced from an online application server. The method begins in step 905. In step 910 all inbound and outbound application link enabling (ALE) configurations are located. In step 915, the ALEs that are located are are configured for the test box. In step 920 all inbound and outbound remote function calls (RFCs) are located, and in step 925 the RFCs that are located are configured for the text box. In step 930, all licenses required for operation of the ERP system are called up and in step 935, all required licenses that are located are configured to run the associated programs. In step 940, all requested trust information and logon groups are configured during the configuration processes in the method above. In step 945a script is executed to record all of the configurations set in steps 915, 925, and 935. In step 950 the method ends.

While the above description describes a particular order in which the integrations are configured and stored, the integrations can be configured and stored in different orders.

In all future simulations of ERP system integrations or updates, the steps above do not need to be repeated because all of the data for the necessary configurations of the test box servers can be imported from the configuration repository. In other words, the script to locate the various integrations is executed once. The located integrations are configured and preserved; the preserved configurations are then accessible for all future simulations, providing a great boost to the efficiency of the integration simulation and testing process. This of course leads to faster integrations and updated of new ERP system conversions.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components or steps described and illustrated with reference to the figures are required for all embodiments or arrangements.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and “comprising”, when used in this specification, specify the presence of stated features, integers, steps, operations, elements, or components, but do not preclude the presence or addition of one or more other features, integers, steps, operations, elements, components, or groups thereof.

Terms of orientation are used herein merely for purposes of convention and referencing and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including.” “comprising.” or “having,” “containing.” “involving.” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A method of preserving integration of an enterprise network throughout multiple system conversion simulations comprising:
reproducing an application server and a database coupled to the application in a test box;
executing a program script to locate all inbound and outbound integrations that functionally connect the test box to other servers in the enterprise network in the manner of the reproduced application server and database;
configuring all of the inbound and outbound integrations of the test box;
exporting all of the configured inbound and outbound integrations in a configuration repository; and
performing a conversion simulation on the test box and enterprise network,
wherein in all future conversion simulations in which a new test box is created, inbound and outbound configurations can be imported from the configuration repository, and
wherein the inbound and outbound integrations are preserved across migrations or conversions between different database platforms such that data can be exported from a first database platform to a second database platform and another and vice versa.

2. The method of claim 1, further comprising:
after an initial simulation:
reproducing the application server and the database coupled to the application server in the test box again;
importing the inbound and outbound configurations to the test box from the configuration repository; and
performing a conversion simulation on the test box and enterprise network.

3. The method of claim 1, wherein the integrations include application link enabling structured data messages.

4. The method of claim 1, wherein the integrations include remote function calls.

5. The method of claim 4, wherein the integrations further include trust configurations required to receive a trusted remote functional call connection.

6. The method of claim 4, wherein the integrations further include logon group load balancing configurations for remote functional call connections.

7. The method of claim 6, wherein the load balancing configuration is dependent on a name of the application server.

8. The method of claim 1, wherein the integrations include license configurations based on hardware and database characteristics of the enterprise network.

9. An enterprise system for which multiple system conversion simulations are performed comprising:
a network of connected application servers, each application server being coupled to a database;
a test box comprising a copy of one of the application servers and the database coupled to the application server; and
a configuration repository coupled to the test box,
wherein the test box executes a program script to locate all inbound and outbound integrations that functionally connect the test box to the application servers in the enterprise network in the manner of the copied application server and database, and
wherein all of the inbound and outbound integrations of the test box are configured, and the configured integrations are exported to the configuration repository, and
wherein the inbound and outbound integrations are preserved across migrations or conversions between different database platforms such that data can be exported from a first database platform to a second database platform and another and vice versa.

10. The enterprise system of claim 9, wherein the test box is configured to import the configured integrations to perform a conversion simulation.

11. The enterprise system of claim 9, wherein the integrations include application link enabling structured data messages.

12. The enterprise system of claim 9, wherein the integrations include remote function calls.

13. The enterprise system of claim 12, wherein the integrations further include trust configurations required to receive a trusted remote functional call connection.

14. The enterprise system of claim 12, wherein the integrations further include logon group load balancing configurations for remote function call connections.

15. The enterprise system of claim 14, wherein the load balancing configuration is dependent on a name of the application server.

16. The enterprise system of claim 9, wherein the integrations include license configurations based on hardware and database characteristics of the enterprise network.
